(19) United States
(12) Patent Application Publication
(10) Pub. No.: US 2015/0081546 A1
(43) Pub. Date: Mar. 19, 2015

(54) SYSTEMS AND METHODS FOR AUTHENTICATION OF AN ENTITY

(71) Applicant: MASTERCARD INTERNATIONAL INCORPORATED, Purchase, NY (US)

(72) Inventor: Rohit Chauhan, Somers, NY (US)

(73) Assignee: MASTERCARD INTERNATIONAL INCORPORATED, Purchase, NY (US)

(21) Appl. No.: 14/030,510

(22) Filed: Sep. 18, 2013

(51) Int. Cl. G06Q 20/40

(52) U.S. Cl. CPC G06Q 20/4097
USPC 705/44

(57) ABSTRACT

A method and system for remote authentication of a first entity by a second entity is provided. The method involves the second entity conveying at least a registration web link to the e-mail address of a first entity; processing a transaction amount on a payment card of the first entity using the payment card number of the first entity; and processing at least two (2) payment card refund transaction amounts on a payment card acceptance account of the first entity. The method also involves receiving information on the registration web link from the first entity, the information including the amounts of the at least two (2) payment card refund transactions obtained by the first entity from an acquiring bank of the first entity; and verifying that the amounts of the at least two (2) payment card refund transactions processed by the second entity match with the amounts of the at least two (2) payment card refund transactions obtained by the first entity from the acquiring bank of the first entity.

### BACKGROUND OF THE DISCLOSURE

1. Field of the Disclosure

The present disclosure relates to systems and methods for authentication of an entity. In particular, the systems and methods of the present disclosure relate to authenticating a merchant in order to reduce risk and increase security for a payment cardholder to conduct an online transaction with the merchant, or for a payment card company to provide services to a merchant.

2. Description of the Related Art

In the growing age of cloud computing and acceptance of transacting confidential communications over relatively open networks, such as the Internet, the need for verifying the identity of an entity has become increasingly important. In particular, phishing attacks are common and can create valid concern about who one is communicating with.

Authentication is of particular concern when confidential information is requested, such as analytical reports, account information, or other types of information concerning person or financial matters, from a custodian of such confidential information. It can be important for the custodian delivering the information to authenticate that the entity requesting the information is the party entitled to the information.

Further, in an e-commerce environment, more and more financial transactions, like consumer purchases of goods and services or fund transfers, are performed on the Internet. When engaging in a financial transaction through the Internet, customers often assume a level of risk, real or imagined, when dealing with relatively unknown entities. Customers may be wary of providing personal information, account information, or transferring money to entities without assurances that the entity is who they claim to be. As a result, online retailers and services have taken steps to try and reduce risk and alleviate customer security and privacy concerns, such as displaying certificates from third parties. But there is an awareness that these steps still may not be authentic, and may not be a proper indicator of the authenticity of the entity.

Thus, there is a need to improve the authentication of merchants and entities in e-commerce so as to reduce risk and increase security for customers engaging in financial transactions. This is particularly so in light of the technical problems and inadequacies of earlier attempts at providing authentication.

### SUMMARY OF THE DISCLOSURE

The present disclosure provides systems and methods for authentication of an entity, e.g., merchant.

The present disclosure also provides systems and methods that relate to authenticating a merchant in order for a payment cardholder to conduct an online transaction with the merchant. The present disclosure further provides systems and methods that relate to authenticating a merchant in order for a payment card company to provide services, e.g., reports, to the merchant.

An embodiment of the present disclosure is a method of authenticating a first entity (e.g., merchant) by a second entity (e.g., payment card company or consumer) that involves receiving by the second entity information concerning the first entity, and conveying by the second entity at least a registration web link to the e-mail address of the first entity. The information can be at least an e-mail address of the first entity and a payment card number of the first entity. The method also involves processing by the second entity a transaction amount on a payment card of the first entity using the payment card number of the first entity; and processing by the second entity at least two (2) payment card refund transaction amounts on a payment card acceptance account of the first entity. The method further involves receiving by the second entity information on the registration web link from the first entity, the information including the amounts of the at least two (2) payment card refund transactions obtained by the first entity from an acquiring bank of the first entity; and verifying by the second entity that the amounts of the at least two (2) payment card refund transactions processed on the payment card acceptance account of the first entity match with the amounts of the at least two (2) payment card refund transactions obtained by the first entity from the acquiring bank of the first entity.

Another embodiment of a method of the present disclosure for authenticating a merchant in order for an entity to conduct an online transaction with the merchant involves receiving, by the entity, information concerning the merchant, and conveying, by the entity, at least a registration web link to the e-mail address of the merchant, and a text of a security code to the cell phone number of the merchant. The information includes, but is not limited to, an e-mail address of the merchant, a credit number of the merchant, and one or more data selected from the group consisting of: a name of the merchant, an address of the merchant, a telephone number of the merchant (land line), a name of individual representing the merchant, a cell phone number of the individual representing the merchant, and an attestation that the information provided by merchant is accurate and true and that the individual representing the merchant is authorized to act on behalf of the merchant and to represent the merchant. The method also involves processing by the entity a transaction amount on a payment card of the merchant using the payment card number of the merchant; and processing by the entity three (3) payment card refund transaction amounts on a payment card acceptance account of merchant. The method further involves receiving by the entity information on the registration web link from the merchant. The information includes the amounts of the three (3) payment card refund transactions obtained by the merchant from an acquiring bank of the merchant, and the security code texted to the cell phone number provided by the merchant. The method yet further involves verifying by the entity that the amounts of the three (3) payment card refund transactions processed on the payment card acceptance account of the merchant match with the amounts of the three (3) payment card refund transactions obtained by the merchant from the acquiring bank of the merchant; and verifying by the entity that the security code texted by the entity to the cell phone number provided by merchant matches with the security code received by the entity on the registration web link from merchant.

One embodiment of the system for authenticating an entity (e.g., merchant) of the present disclosure includes a database configured to store authentication information associated with the entity; and a receiving device configured to receive information concerning the entity. The information comprises (i) at least an e-mail address and a payment card number of the entity and (ii) the amounts of the at least two (2) payment card refund transactions obtained by the entity from an acquiring bank of the entity. The system also includes at least one supplying device configured to supply at least a registration web link to the e-mail address of the entity. The system further includes a processor. The processor is configured to process a transaction amount on a payment card of the entity using the payment card number of the entity, and process at least two (2) payment card refund transaction amounts on a payment card acceptance account of the entity. The processor also authenticates the entity by verifying that the amounts of the at least two (2) payment card refund transactions processed on the payment card acceptance account of the entity match with amounts of at least two (2) payment card refund transactions obtained by the entity from the acquiring bank of the entity; and updates, in the database, the authentication information associated with the entity based on the authenticating of the entity.

These and other systems, methods, objects, features, and advantages of the present disclosure will be apparent to those skilled in the art from the following detailed description of the preferred embodiment and the drawings.

### BRIEF DESCRIPTION OF THE DRAWINGS

FIG. 1 is a block diagram illustrating a high-level view of system architecture of a financial transaction processing system in accordance with exemplary embodiments.

FIGS. 2A and 2B are block diagrams illustrating a first system and a second system, respectively, for authenticating an entity in accordance with exemplary embodiments.

FIG. 3 is a block diagram illustrating a processing server in accordance with exemplary embodiments.

FIGS. 4A and 4B are a flow diagram illustrating a first exemplary method for authenticating an entity in accordance with exemplary embodiments.

FIG. 5 is a flow chart illustrating a first exemplary method of authenticating an entity in accordance with exemplary embodiments.

FIGS. 6A and 6B are a flow diagram illustrating a second exemplary method for authenticating an entity in accordance with exemplary embodiments.

FIG. 7 is a flow chart illustrating a second exemplary method of authenticating an entity in accordance with exemplary embodiments.

### DESCRIPTION OF THE PREFERRED EMBODIMENT

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these exemplary embodiments are provided so that the present disclosure satisfies applicable legal requirements. Also, like numbers refer to like elements throughout.

As used herein, “entity” or “entities” includes one or more persons, organizations, businesses, institutions and/or other entities, including but not limited to, financial institutions, and services providers, that implement one or more portions of one or more embodiments described and/or contemplated herein. In particular, entities include a person, business, school, club, fraternity or sorority, an organization having members in a particular trade or profession, sales representative for particular products, charity, not-for-profit organization, labor union, local government, government agency, or political party.

As used herein, “merchant” includes the merchant or a representative of the merchant.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium reside in an Application Specific Integrated Circuit (ASIC). In the alternative, the processor and the storage medium reside as discrete components in a computing device. Additionally, in some embodiments, the events and/or actions of a method reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium is any available media that can be accessed by a computer. By way of example, and not limitation, such computer-readable media includes RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein include compact disc (CD), laser disc, optical disc, digital versatile disc (DVD), floppy disk and blu-ray disc, where disks usually reproduce data magnetically and discs usually reproduce data optically with lasers. Combinations of the above are also included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that direct a computer or other programmable data processing apparatus to function in a particular manner, such that the instructions stored in the computer readable memory produce an article of manufacture including instruction means, which implement the function/act specified in the flowchart and/or block diagram block(s).

The computer program instructions can be loaded onto a computer or other programmable data processing apparatus to cause a series of operational steps to be performed on the computer or other programmable apparatus to produce a computer-implemented process so that the instructions, which execute on the computer or other programmable apparatus, provide steps for implementing the functions/acts specified in the flowchart and/or block diagram block(s). Alternatively, computer program implemented steps or acts can be combined with operator or human implemented steps or acts in order to carry out an embodiment of the disclosure.

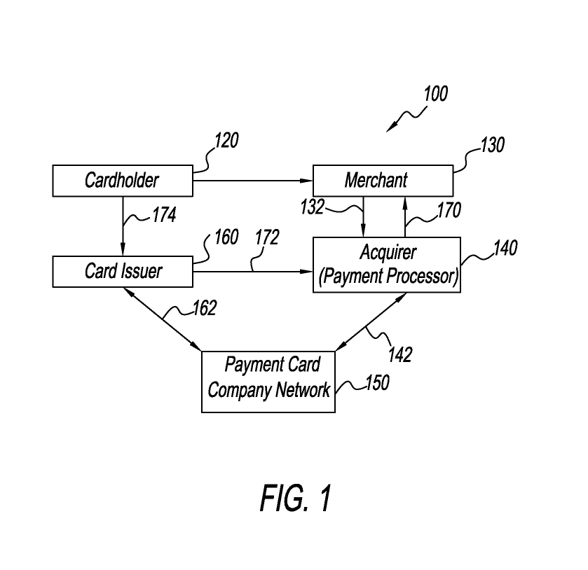

Referring to the drawings and, in particular, FIG. 1, there is shown a four party payment (credit, debit or other) card system generally represented by reference numeral 100. In card system 100, cardholder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the cardholder completes the purchase and receives a receipt.

The account of the merchant 130 is credited, via 170, by the acquirer 140. The card issuer 160 pays, via 172, the acquirer 140. Eventually, the cardholder 120 pays, via 174, the card issuer 160.

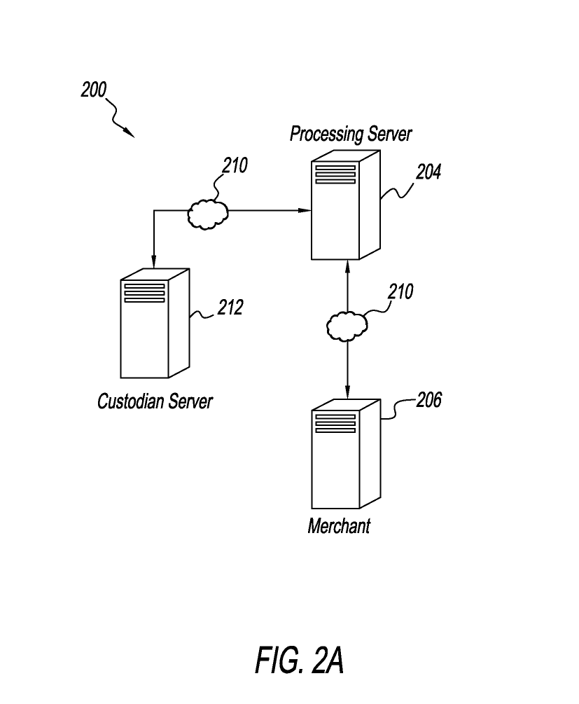

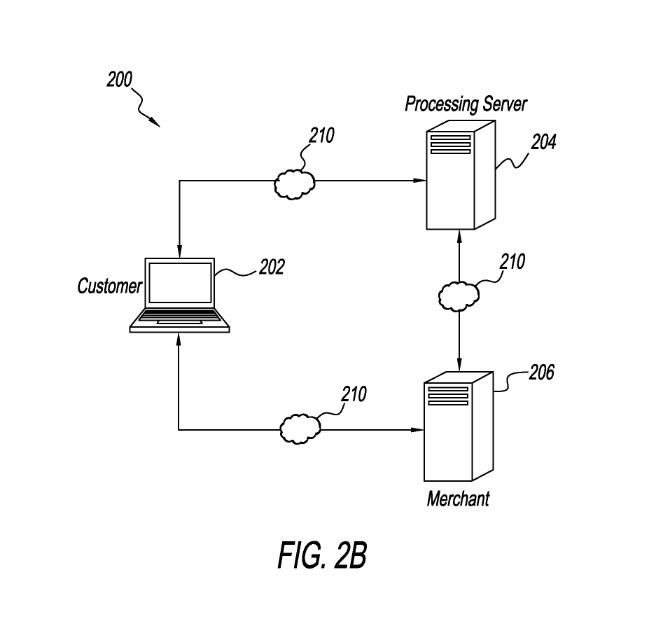

FIG. 2A illustrates a system 200 for authenticating an entity, e.g., a merchant. The system 200 includes a processing server 204 and a merchant 206. Each of the components can be connected to a network 210. The network 210 is any type of wired or wireless network suitable for performing the function as disclosed herein, as will be apparent to persons having skill in the relevant art. The network 210 includes local area network (LAN), wireless area network, the internet, Wi-Fi, fiber optic, coaxial cable, infrared, radio frequency, and the like either alone or in combinations. For example, the network 210 can be part of a payment card processing network, such as MasterCard's BankNet. The merchant 206 can, if desired, receive information from a custodian 212 of confidential, private, or sensitive information. The custodian 212 may or may not be part of a processing server 204. The processing server 204 can serve to authenticate the merchant 206 prior to the release of such information from the custodian 212, for instance. It should be noted that the custodian 212, processing server 204 and merchant 206 are computers or computer systems. However, in certain limited instances, the custodian 212 and the merchant can be natural persons in communication through a network.

The processing server 204 can be configured to receive authentication information from the merchant 206 and to process payment card transactions on the payment card of merchant 206, as discussed below. The merchant 206 can request access to the information held by the custodian 212.

The processing server 204 can be any type of server suitable for performing the functions described herein, such as a general purpose computer, configured as disclosed herein to become a specific purpose computer, or cloud computing, or any other form of computer capable of carrying out the functions described herein. The processing server 204 can be a single system, e.g., a single specific purpose computer, or comprised of several interconnected computers via for instance a network 210, or servers as in a server form. The processing server 204 can be configured to process payment card transactions on the payment card of merchant 206 and to receive additional transaction details that may be required to uniquely authenticate the merchant 206. The processing server 204 can be configured to receive authentication information from the merchant 206, such as (a) the name of the merchant 206, (b) address of the merchant, (c) telephone number of the merchant, (d) name of the individual representing the merchant, (e) credit card number of the merchant and/or individual representing the merchant (which will be billed for any services if credit card issued in the name of the individual representing the merchant 206), (f) e-mail address of the merchant and the individual representing the merchant, and (g) cell phone number of the merchant and the individual representing the merchant. Additional authentication information can include, for example, an attestation of the merchant 206 or the individual representing the merchant 206 that all information provided to a payment card company or other entity is true and the individual is authorized to represent the merchant.

The merchant 206 can be configured to be part of the four party payment (credit, debit or other) card system represented in FIG. 1. The processing server 204 can authenticate the merchant 206 based on transaction details including processing payment card transactions on the payment card of merchant 206 that can be required to uniquely authenticate the merchant 206. In an exemplary embodiment, the processing server 204 will process a payment card transaction (e.g., $0.99) on the payment card of merchant 206 and thereafter process at least two (2) payment card credit transactions (refunds) on the payment card acceptance account of merchant 206. For example, the processing server 204 will process three (3) payment card credit transactions (refunds) on the payment card acceptance account of merchant 206 (e.g., $0.05, $0.31 and $0.63). As part of the authentication, the merchant 206 or individual representing the merchant 206 will obtain the exact amounts of the payment card credit transactions (refunds) (e.g., $0.05, $0.31 and $0.63) from the merchant's acquiring bank. The merchant's acquiring bank is part of the four party payment (credit, debit or other) card system represented in FIG. 1.

In addition to processing the payment card transactions on the payment card of merchant 206, the payment card company will also e-mail a registration web link URL to the e-mail address provided by the merchant 206 or individual representing the merchant. The payment card company will also text a security code to the cell phone number of the merchant 206 or individual representing the merchant.

After getting the exact amounts of the payment card credit transactions (refunds) (e.g., $0.05, $0.31 and $0.63) from the merchant's acquiring bank, the merchant 206 or individual representing the merchant will access the registration web link URL provided in the e-mail from the payment card company. An authentication screen/menu will appear with instructions completing authentication. The merchant 206 or individual representing the merchant will enter on the authentication screen the security code that was sent on the mobile phone to the merchant or individual representing the merchant by the payment card company. The merchant 206 or individual representing the merchant will then enter on the authentication screen the exact amounts of the payment card credit transactions (refunds) (e.g., $0.05, $0.31 and $0.63) from the merchant's acquiring bank.

Other authentication information can include, for example, the land line telephone number of the merchant 206 or individual representing the merchant. The authentication information is then conveyed to the processing server 204 to compare and verify transaction details as part of the authentication process. If all entries made on the authentication screen are correct, the merchant is authenticated. The online registration process is completed. Upon authenticating the merchant 206, the processing server 204 may notify the merchant of the authentication, which may then engage in accessing the information held by the custodian 212, for instance. An e-mail, text on the cell phone, a voice mail on the land line phone, and a letter via the regular mail at the merchant address will be sent confirming the registration.

If the merchant 206 or individual representing the merchant can successfully complete the authentication process, then the following has occurred. The merchant 206 or individual representing the merchant has been successfully linked to a credit card number, an e-mail address and a cell phone number. Also, an individual has been successfully linked to the merchant 206. For purposes of this disclosure, it is the assumption that only individuals working at a merchant with sufficient responsibilities will have access to transaction level details from the merchant's acquiring bank.

FIG. 2B illustrates a system 200 for authenticating an entity which system is similar to that shown in FIG. 2A but additionally includes a third party requesting that an entity be authenticated, called a “customer” and understood to be any entity (person or business for example) that wishes to authenticate an entity 206. The system 200 includes a customer 202, a processing server 204, and a merchant 206. The customer 202 is in the form of a computer capable of communication owned or controlled by a person who is interested in authenticating an entity (and does not have to be a prospective customer). In some instances, communications occurs with a natural person. Each component is connected to a network 210. The network 210 can be any type of wired or wireless network suitable for performing the functions disclosed herein, as will be apparent to persons having skill in the relevant art, such as local area network (LAN), wireless area network (WAN), the Internet, Wi-Fi, fiber optic, coaxial cable, infrared, radio frequency (RF), and the like, and combinations thereof, such as in a payment processing network.

The customer 202 can desire to engage in a financial transaction with an entity. The entity can be any entity that is capable of engaging in a financial transaction, such as the merchant 206, a person, a business, and the like. The financial transaction can be any transaction between two parties (e.g., between the customer 202 and the merchant 206) that includes the transfer of funds from one party (e.g., the customer 202) to the other party (e.g., the merchant 206), such as the purchase of goods or services, the giving or repayment of a loan, a refund, and the like. The customer 202 can desire to authenticate the identity of the merchant 202 prior to engaging in the financial transaction.

The processing server 204 can be configured to receive an authentication request from the customer 202 and to authenticate the merchant 206, as discussed below. The processing server 204 can be any type of server suitable for performing the functions as disclosed herein, such as a general purpose computer configured as disclosed herein to become a specific purpose computer, and the like. The processing server 204 can be similar to that described for FIG. 2A above.

The merchant 206 can be configured to be part of the four party payment (credit, debit or other) card system represented in FIG. 1. The processing server 204 can authenticate the merchant 206 based on transaction details including processing payment card transactions on the payment card of merchant 206 that can be required to uniquely authenticate the merchant 206, similar to that described for FIG. 2A above.

The authentication process represented in FIG. 2B can be similar to the authentication process described for FIG. 2A above.

In the embodiment represented in FIG. 2B, the customer 202 authenticates the identity of the merchant 206 prior to engaging in the financial transaction. The financial transaction can be any transaction between two parties (e.g., between the customer 202 and the merchant 206) that includes the transfer of funds from one party (e.g., the customer 202) to the other party (e.g., the merchant 206), such as the purchase of goods or services, the giving or repayment of a loan, a refund, and the like.

The method represented in FIG. 2B is useful for authenticating an entity, such as on behalf of a consumer (e.g., the consumer 202) for providing security and confidence when engaging in a financial transaction online. It should be understood that the possible applications for authenticating an entity by the systems and methods disclosed herein can exceed performing authentication for the purposes of providing added security for financial transactions in e-commerce.

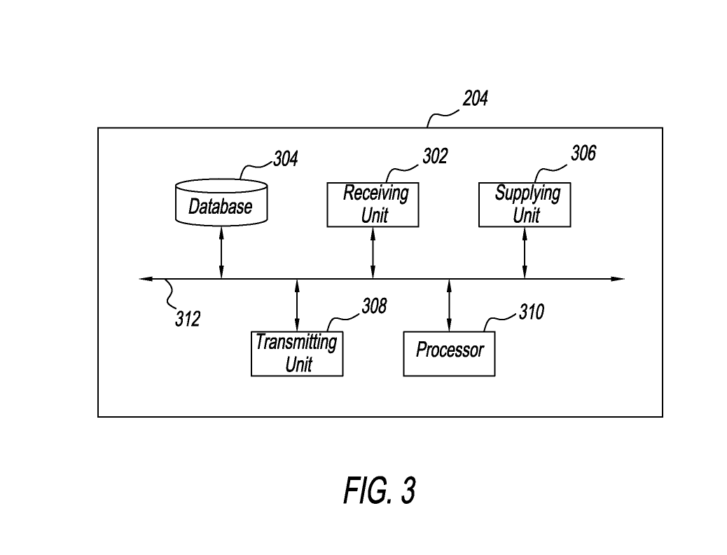

Referring to FIG. 3, the processing server 204 includes a receiving unit 302, a database 304, a supplying unit 306, a transmitting unit 308, and a processor 310. Each component can be connected via a bus 312. Suitable types and configurations of the bus 312 will be apparent to persons having skill in the relevant art.

The receiving unit 302 can be configured to receive (e.g., via the network 210) authentication information as described herein from the merchant 206. The receiving unit 302 can be configured to receive (e.g., via the network 210) an authentication request (e.g., from the customer 202). It can be in the form of a network gateway, or other equipment capable of receiving and processing communications over a network. The receiving unit 302 can be configured to receive (e.g., via the network 210) other authentication information (e.g., additional transaction details) that can be required for uniqueness.

The database 304 can be configured to store a profile associated with the merchant 206. The profile can include at least an authentication status for the merchant 206, generally but not limited to, the geological or virtual (e.g., network domain) location of the merchant or the part of the merchant that a future communication or transaction is to occur. The authentication status can be an indication of if the merchant 206 has been successfully authenticated. In some embodiments, the profile can include account information for a financial account associated with the merchant 206, to or from which the merchant wishes to transact. In a further embodiment, multiple financial accounts may be associated with the merchant 206, or the merchant can be associated with multiple profiles each including a unique financial account.

The database 304 can be configured in any type of suitable database configuration, such as a relational database, a structured query language (SQL) database, a distributed database, an object database, and the like. The data in the database 304 can be stored on any type of suitable computer readable media, such as optical storage (e.g., a compact disc, digital versatile disc, blu-ray disc, and the like.) or magnetic tape storage (e.g., a hard disk drive). Suitable database configurations and data storage types will be apparent to persons having skill in the relevant art.

The supplying unit 306 can be configured to supply a registration web link URL for authentication. Other additional information required for authentication can also be supplied by supplying unit 306.

The transmitting unit 308 can be configured to transmit the supplied registration web link URL and additional authentication information to a third party (e.g., such as the merchant 206, an acceptance location of the merchant, a merchant representative, and the like) via the network 210. The authentication information can be transmitted by e-mail via the e-mail address provided by the merchant 206 or individual representing the merchant. The merchant 206 or individual representing the merchant will access the registration web link URL provided in the e-mail from the payment card company. An authentication screen/menu will appear with instructions completing authentication.

The processor 310 can be configured to process payment card transactions on the payment card of merchant 206 and to supply additional transaction details that can be required to uniquely authenticate the merchant 206. For example, the processor 310 will process a payment card transaction (e.g., $0.99) on the payment card of merchant 206 and thereafter process at least two (2) payment card credit transactions (refunds) on the payment card acceptance account of merchant. For example, the processor 310 will process three (3) payment card credit transactions (refunds) on the payment card acceptance account of merchant 206 (e.g., $0.05, $0.31 and $0.63). The processing server 204 and the processor 310 can be configured to be part of the payment card company network of the four party payment (credit, debit or other) card system represented in FIG. 1.

The processor 310 can be further configured to authenticate the merchant 206 based on the captured transaction details and information provided by the merchant and/or the individual representing the merchant. Authentication will include the merchant 206 or individual representing the merchant accessing the registration web link URL provided in the e-mail from the payment card company. An authentication screen/menu will appear with instructions completing authentication. The merchant 206 or individual representing the merchant will enter on the authentication screen the security code that was sent on the mobile phone to the merchant 206 or individual representing the merchant by the payment card company. The merchant 206 or individual representing the merchant will then enter on the authentication screen the exact amounts of the payment card credit transactions (refunds) (e.g., $0.05, $0.31 and $0.63) from the merchant's acquiring bank.

Other authentication information can include, for example, the land line telephone number of the merchant 206 or individual representing the merchant. The authentication information is then conveyed to the processing server 204 and processor 310 to compare and verify transaction details as part of the authentication process. If all entries made on the authentication screen are correct, the merchant is authenticated.

The processor 310 can be further configured to update the authentication status including in the profile associated with the merchant 206 in the database 304. The authentication status may be updated to reflect the success or failure to authenticate the merchant 206 and to record (or update) the location of the merchant. The transmitting unit 308 can be configured to notify the customer 202 of the updated authentication status of the merchant 206. The customer 202, the custodian server 212 and/or the processor 204 can then feel confident in the authenticity of the merchant 206 and engage in a financial transaction with the merchant from the same location.

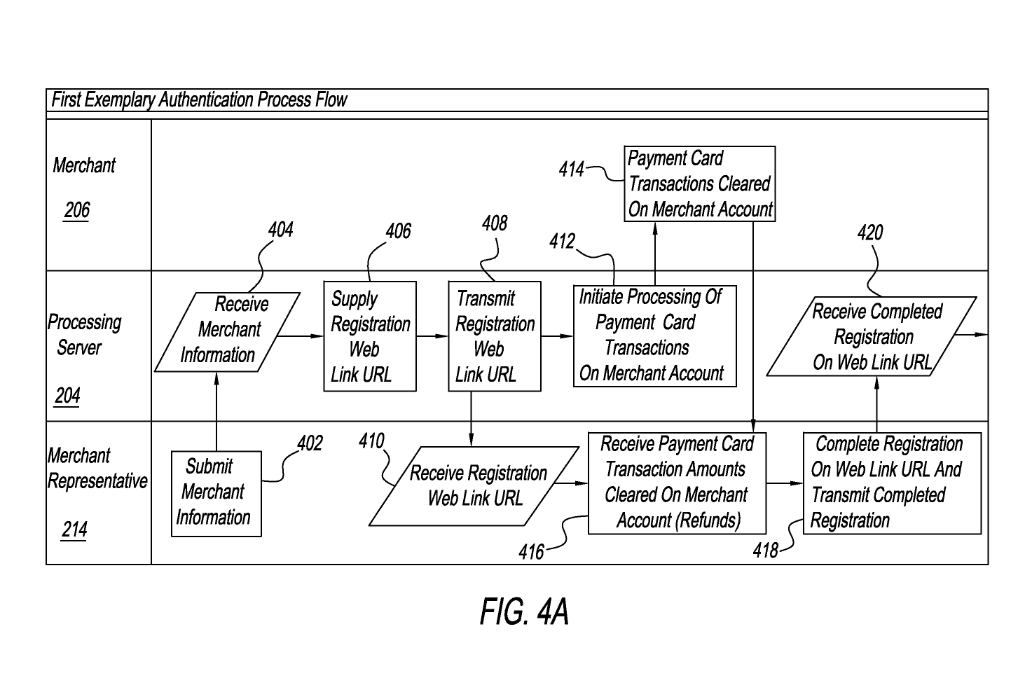

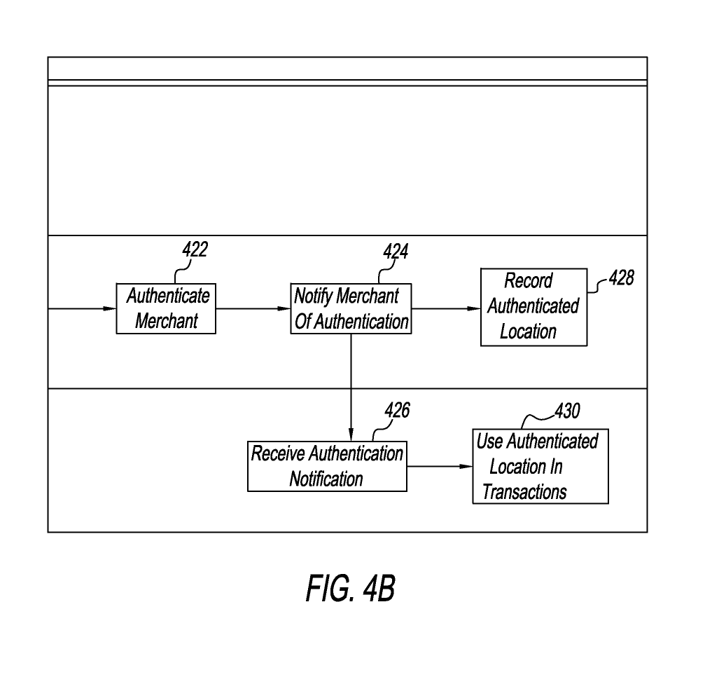

Referring to FIGS. 4A and 4B, a first method for authenticating an entity upon the request of the same of the entity, the card processor, or a third party on behalf of the entity (e.g., such as the merchant representative 214 on behalf of the merchant 206) is illustrated in flow diagrams. In step 402, the merchant representative 214 initiates an authentication request. The authentication request includes (e.g., via the network 210) authentication information as described herein from the merchant 206.

The processing server 204 receives the authentication request in step 404. The processing server 204 then supplies a registration web link URL and other additional information required for authentication for step 406. This registration web link URL and other additional information are then transmitted in step 408 to the merchant representative 214. The merchant representative 214 receives the registration web link URL and other additional information at step 410. At step 412, processing server 204 will initiate processing a payment card transaction (e.g., $0.99) on the payment card of merchant 206 and thereafter processing at least two (2) payment card credit transactions (refunds) on the payment card acceptance account of merchant. For example, the processing server 204 will process three (3) payment card credit transactions (refunds) on the payment card acceptance account of merchant 206 (e.g., $0.05, $0.31 and $0.63).

At step 414, the merchant 206 obtains the exact amounts of the payment card credit transactions (refunds) (e.g., $0.05, $0.31 and $0.63) from the merchant's acquiring bank, and this information is conveyed to the merchant representative 214. At step 416, the merchant representative 214 receives from the merchant 206 the exact amounts of the payment card credit transactions (refunds) (e.g., $0.05, $0.31 and $0.63) obtained from the merchant's acquiring bank.

At step 418, the merchant representative 214 accesses the registration web link URL provided in step 410. An authentication screen/menu appears with instructions completing authentication. The merchant representative 214 enters on the authentication screen the security code that was sent on the mobile phone to the merchant 206 or the merchant representative 214 by the payment card company. The merchant representative 214 then enters on the authentication screen the exact amounts of the payment card credit transactions (refunds) (e.g., $0.05, $0.31 and $0.63) from the merchant's acquiring bank. The completed authentication screen including transaction details are received at the processing server 204 in step 420. The merchant 206 and/or the merchant representative 214 are then authenticated in step 422. By authenticated, it is noted that the authentication can be a determination that the merchant is not the intended merchant. In step 424, the merchant representative 214 is notified of the authentication and in step 426, the processing server 204 records the authenticated location to be used in future transactions when as shown in step 430. Each transaction alleged to come from the merchant that originates without location can then be relied upon as the merchant's authenticated location. This can facilitate communication with the custodian of confidential, private or sensitive information 212, noting that this information can include financial transactions as well. The merchant representative 214 receives an authentication notification as well in step 428.

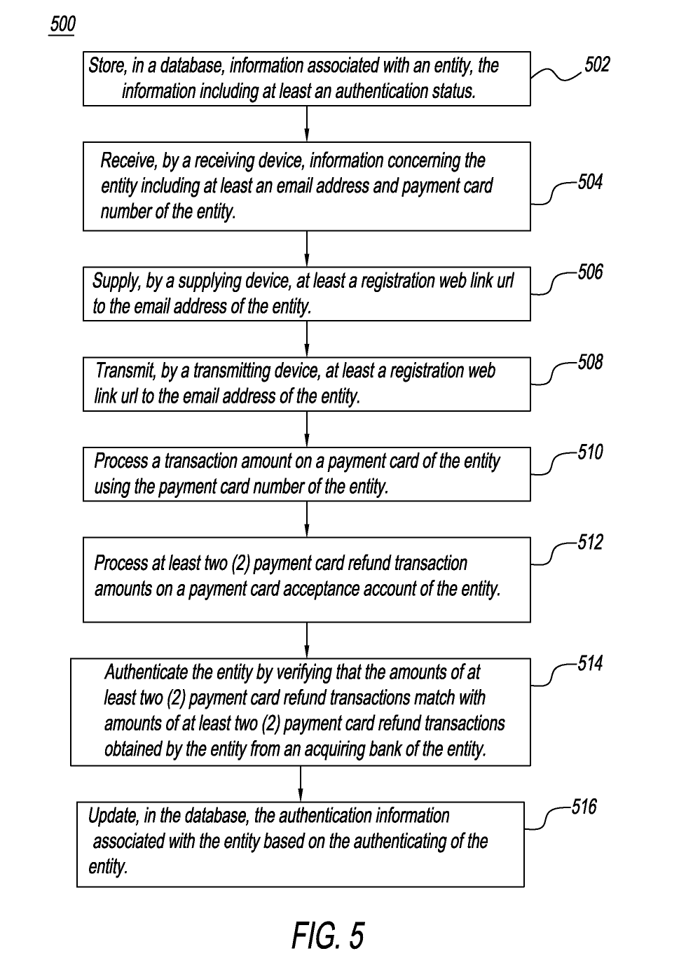

An exemplary merchant authentication process 500 is shown in FIG. 5. In FIG. 5, step 502 stores, in the database, a profile associated with an entity, the profile including at least an authentication status and a location. In step 504, merchant authorization information is received in the receiving device of the card processor 204. The receiving device is configured to receive (e.g., via the network 210) authentication information as described herein from the merchant 206.

In step 506, a registration web link URL and other additional information required for authentication are supplied, by virtue of the supplying unit. In step 508, the supplied registration web link URL and other additional information required for authentication are transmitted, by a transmitting device, to the merchant 206.

In step 510, a processing device initiates processing a payment card transaction (e.g., $0.99) on the payment card of the merchant 206 and thereafter processing at least two (2) payment card credit transactions (refunds) on the payment card acceptance account of the merchant. For example, the processing device will process three (3) payment card credit transactions (refunds) on the payment card acceptance account of the merchant 206 (e.g., $0.05, $0.31 and $0.63).

At step 512, the processing device authenticates the merchant 206 based on the captured transaction details and information provided by the merchant and the individual representing the merchant. Authentication will include the merchant 206 or individual representing the merchant accessing the registration web link URL provided in the e-mail from the payment card company. An authentication screen/menu will appear with instructions completing authentication. The merchant 206 or individual representing the merchant will enter on the authentication screen the security code that was sent on the mobile phone to the merchant 206 or individual representing the merchant by the payment card company. The merchant 206 or individual representing the merchant will then enter on the authentication screen the exact amounts of the payment card credit transactions (refunds) (e.g., $0.05, $0.31 and $0.63) from the merchant's acquiring bank.

Other authentication information can include, for example, the land line telephone number of the merchant 206 or individual representing the merchant. The authentication information is then conveyed to the processing device to compare and verify transaction details as part of the authentication process. If all entries made on the authentication screen are correct, the merchant is authenticated.

At step 514, the processor 310 can update the authentication status including in the profile associated with the merchant 206 in the database 304. The authentication status can be updated to reflect the success or failure to authenticate the merchant 206 and to record (or update) the location of the merchant. The transmitting unit 308 can be configured to notify the customer 202 of the updated authentication status of the merchant 206. The customer 202, the custodian 212 and/or the processor 204 can then feel confident in the authenticity of the merchant 206 and engage in a financial transaction with the merchant from the same location.

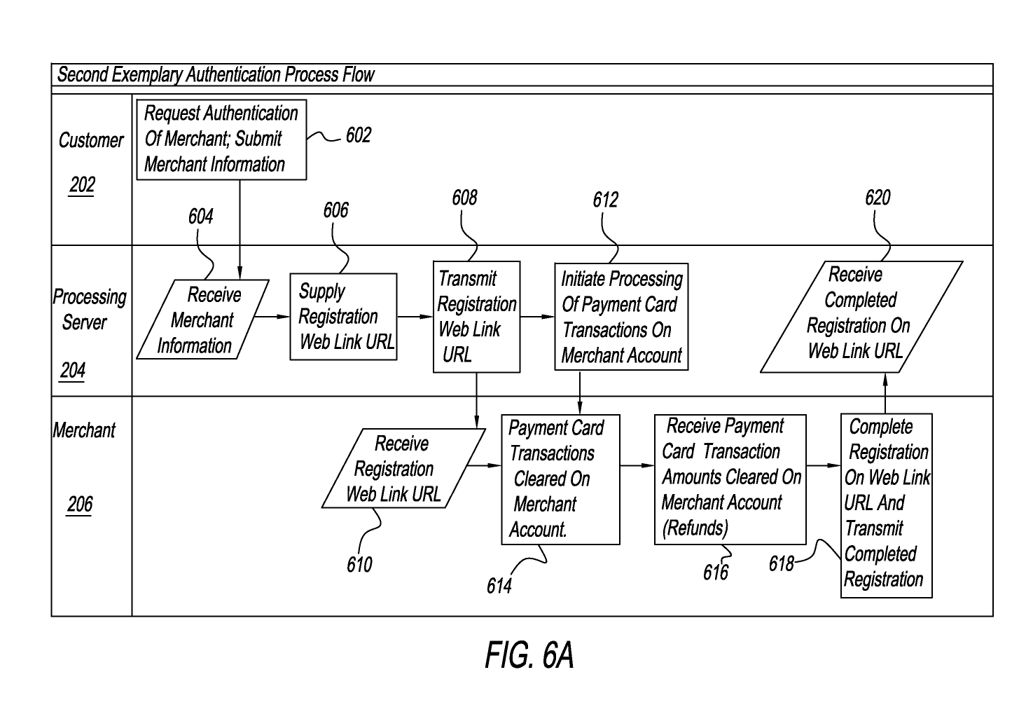

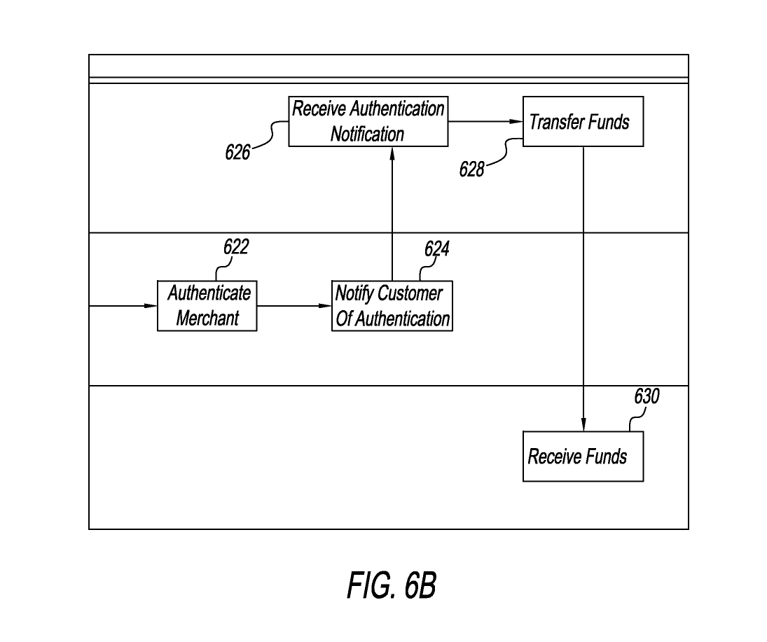

FIGS. 6A and 6B illustrate a second method for authentication of an entity upon the request of a customer.

In step 602, a customer (e.g., the customer 202) requests authentication of a merchant (e.g., the merchant 206). In an exemplary embodiment, the authentication request can include the authentication information described herein. The customer 202 can transmit (e.g., via the network 210) the authentication request to a processing server (e.g., the processing server 204). The authentication request can be conventional in nature. In one embodiment, the customer 202 can transmit the authentication request via a webpage by or on behalf of the processing server 204.

In step 604, the processing server 204 can receive the authentication request and initiate an authorization process. The processing server 204 can identify a profile or information (e.g., stored in the database 304) associated the merchant 206 based on the authentication request. If no profile is identified, the processing server 204 can create a profile for the merchant 206. Then, in step 606, the processing server 204 supplies a registration web link URL and other additional information required for authentication for step 606. This registration web link URL and other additional information are then transmitted in step 608 to the merchant 206. The merchant 206 receives the registration web link URL and other additional information at step 610. At step 612, processing server 204 initiates processing a payment card transaction (e.g., $0.99) on the payment card of merchant 206 and thereafter processing at least two (2) payment card credit transactions (refunds) on the payment card acceptance account of merchant. For example, the processing server 204 will process three (3) payment card credit transactions (refunds) on the payment card acceptance account of merchant (e.g., $0.05, $0.31 and $0.63).

At step 614, the merchant 206 obtains the exact amounts of the payment card credit transactions (refunds) (e.g., $0.05, $0.31 and $0.63) from the merchant's acquiring bank. At step 616, the merchant 206 receives the exact amounts of the payment card credit transactions (refunds) (e.g., $0.05, $0.31 and $0.63) obtained from the merchant's acquiring bank.

At step 618, the merchant 206 accesses the registration web link URL provided in step 610. An authentication screen/menu appears with instructions completing authentication. The merchant 206 enters on the authentication screen the security code that was sent on the mobile phone to the merchant by the payment card company. The merchant 206 then enters on the authentication screen the exact amounts of the payment card credit transactions (refunds) (e.g., $0.05, $0.31 and $0.63) from the merchant's acquiring bank. The completed authentication screen including transaction details are received at the processing server 204 in step 620. The merchant 206 is then authenticated in step 622. By authenticated, it is noted that the authentication can be a determination that the merchant is not the intended merchant. The authentication information including transaction details is compared and verified as part of the authentication process. If all of the entries made on the authentication screen are correct, the merchant is authenticated.

In step 624, the processing server 204 can notify (e.g., by the transmitting unit 308) the customer 202 of the success or failure of the authentication of the merchant 206. Exemplary methods of notification can include electronic mail, a text message (e.g., a short message service message), notification via a webpage portal, or any other suitable method of notification as will be apparent to persons having skill in the relevant art. In step 626, the customer 202 can receive the notification (e.g., by viewing the email, logging in to the website where the authentication request was submitted, etc.). If the customer 202 is satisfied with the results, then the customer 202 can, in step 628, transfer funds to the merchant 206, who receives the funds in step 630.

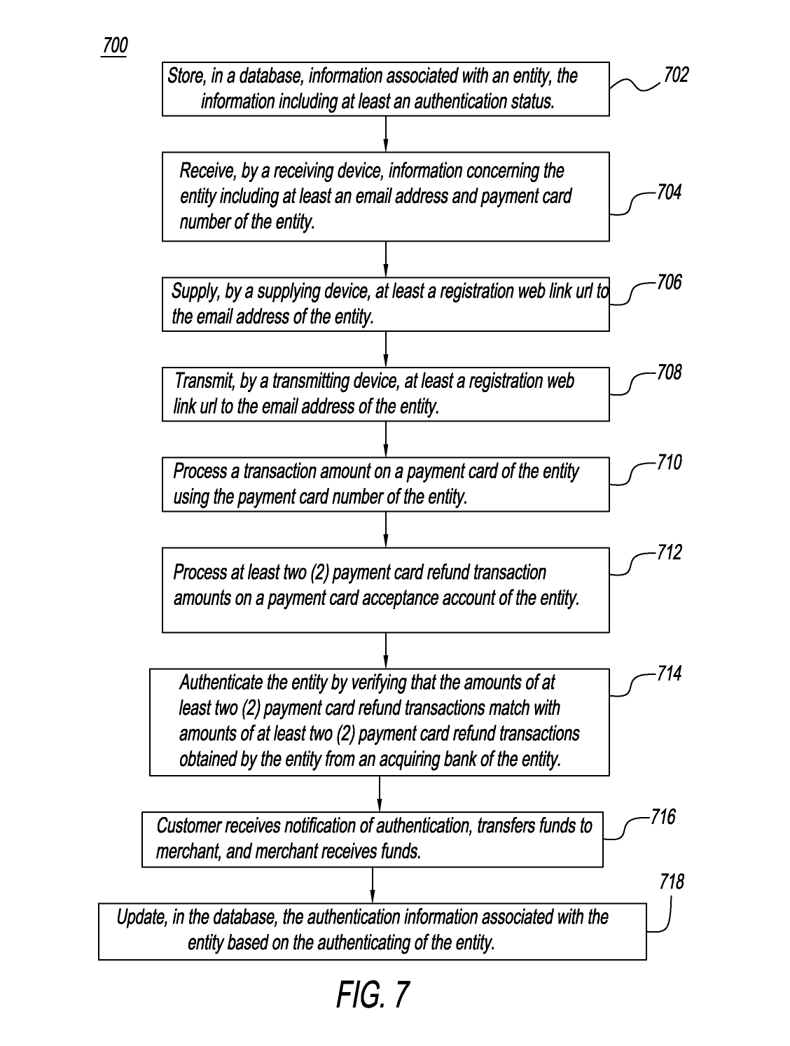

Referring to FIG. 7, an exemplary method 700 for authenticating an entity is shown.

In step 702, a profile associated with an entity (e.g., the merchant 206) can be stored in a database (e.g., the database 304), the profile including at least an authentication status. In one embodiment, the profile can include a financial account associated with the entity.

In step 704, merchant authorization information is received in the receiving device of the card processor 204. The receiving device is configured to receive (e.g., via the network 210) authentication information as described herein from the merchant 206.

In step 706, a registration web link URL and other additional information required for authentication are supplied, by virtue of the supplying unit. In step 708, the supplied registration web link URL and other additional information required for authentication are transmitted, by a transmitting device (e.g., by transmitting unit 308), to a third party. In an exemplary embodiment, the third party is the entity (e.g., merchant). In an alternative embodiment, the third party acts on behalf of the entity (e.g., the merchant representative 214).

In step 710, a processing device initiates processing a payment card transaction (e.g., $0.99) on the payment card of merchant 206 and thereafter processing at least two (2) payment card credit transactions (refunds) on the payment card acceptance account of merchant. For example, the processing device will process three (3) payment card credit transactions (refunds) on the payment card acceptance account of merchant 206 (e.g., $0.05, $0.31 and $0.63).

At step 712, the processing device authenticates the merchant 206 based on the captured transaction details and information provided by the merchant and/or the individual representing the merchant. Authentication will include the merchant 206 or individual representing the merchant accessing the registration web link URL provided in the e-mail from the payment card company. An authentication screen/menu will appear with instructions completing authentication. The merchant 206 or individual representing the merchant will enter on the authentication screen the security code that was sent on the mobile phone to the merchant or individual representing the merchant by the payment card company. The merchant 206 or individual representing the merchant will then enter on the authentication screen the exact amounts of the payment card credit transactions (refunds) (e.g., $0.05, $0.31 and $0.63) from the merchant's acquiring bank.

Other authentication information can include, for example, the land line telephone number of the merchant 206 or individual representing the merchant. The authentication information is then conveyed to the processing device to compare and verify transaction details as part of the authentication process. If all of the entries made on the authentication screen are correct, the merchant is authenticated.

At step 714, the customer 202 receives notification of the merchant authentication. The customer 202 then transfers funds to the merchant 206, and the merchant receives the funds.

At step 716, the processor 310 can update the authentication status including in the profile associated with the merchant 206 in the database 304. The authentication status can be updated to reflect the success or failure to authenticate the merchant 206 and to record (or update) the location of the merchant. The transmitting unit 308 can be configured to notify the customer 202 of the updated authentication status of the merchant 206. The customer 202, the custodian 212 and/or the processor 204 can then feel confident in the authenticity of the merchant 206 and engage in a financial transaction with the merchant from the same location.

The method 700 can be useful in authenticating an entity, such as on behalf of a consumer (e.g., the consumer 202) for providing security and confidence when engaging in a financial transaction online. It should be understood that the possible applications for authenticating an entity by the systems and methods disclosed herein can exceed performing authentication for the purposes of providing added security for financial transactions in e-commerce.

For example, a payment card processor (e.g., MasterCard®) acting as the processing server 204 can be in a unique position to possess, beneficial market information. For instance, by processing a vast number of financial transactions, a payment card processor can collect useful data on specific industries, markets, trends, consumers, geographic locations, and the like. This type of information can be made available only to entities that can authenticate themselves as being a particular entity, of a particular industry, or in a particular location.

By way of example, a merchant (e.g., the merchant 206) at a specific geographic location (e.g., a specified postal code) can desire market reports on the status of the market in their specific geographic location. A payment card processor (e.g., the processing server 204) can compile market reports based on financial transactions processed in the area of the merchant based on location information. The payment card processor can request the merchant to authenticate themselves as being a merchant operating in the specific geographic location. The payment card processor can use authentication methods disclosed herein (e.g., the methods 500 and 700) and authenticate the merchant's location by capturing location identifier information (e.g., such as by specifying a particular point of sale terminal for the initiating of the financial transaction). Upon authenticating that the merchant is indeed in the specific geographic location, the payment card processor can feel confident in the distribution of the market report.

In some instances, a customer can benefit from authentication of an entity prior to engaging in a business contract or before providing or procuring services from the entity. For example, a customer (e.g., the customer 202) looking for a contractor for a project where the contractor is or may be exposed to sensitive information, can be referred to a specific merchant (e.g., the merchant 206) with a reputation for honesty and confidentiality. The customer can contact the merchant 206 and have the merchant 206 authenticate their identity prior to discussing any details to receive an estimate, to avoid an unreliable third party posing as the merchant 206. The merchant 206 can authenticate their identity using systems or methods disclosed herein, which provide the customer with the confidence necessary to expose the merchant to sensitive information.

Techniques consistent with the present disclosure provide, among other features, systems and methods for distributing content to devices, initiating financial transactions, processing electronic financial transactions, and indirectly controlling websites. While various exemplary embodiments of the disclosed systems and methods have been described above, it should be understood that they have been presented for purposes of example only, not limitations. It is not exhaustive and does not limit the present disclosure to the precise form disclosed herein. Modifications and variations are possible in light of the above teachings, and can be acquired from practicing of the present disclosure, without departing from the breadth or scope of the present disclosure.

The terms “comprises” or “comprising” are interpreted as specifying the presence of the stated features, integers, steps or components, but not precluding the presence of one or more other features, integers, steps or components or groups thereof.

It should be understood that various alternatives, combinations and modifications of the present disclosure could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for an entity to authenticate a merchant in order for the entity to conduct an online transaction with the merchant, said method comprising:
receiving information from the merchant concerning the merchant, said information comprising at least an e-mail address of the merchant and a payment card number of the merchant;
conveying at least a registration web link to the e-mail address of the merchant;
processing a transaction amount on a payment card of merchant using the payment card number of the merchant;
processing at least two (2) payment card refund transaction amounts on a payment card acceptance account of the merchant;
receiving information on the registration web link from the merchant, said information including the amounts of the at least two (2) payment card refund transactions obtained by the merchant from an acquiring bank of the merchant; and
verifying that the amounts of the at least two (2) payment card refund transactions processed on the payment card acceptance account of the merchant match with the amounts of the at least two (2) payment card refund transactions obtained by the merchant from the acquiring bank of the merchant.

2. The method of claim 1, wherein the received information further comprises one or more data selected from the group consisting of: a name of the merchant, an address of the merchant, a telephone number of the merchant (land line), a name of individual representing the merchant, and a cell phone number of the merchant and an individual representing the merchant.

3. The method of claim 2, wherein the received information further comprises an attestation that the received information is accurate and true and that any individual representing the merchant is authorized to act on behalf of the merchant and to represent the merchant.

4. The method of claim 2, further comprising conveying a text of a security code to the cell phone number of merchant.

5. The method of claim 1, wherein the at least two (2) payment card refund transaction amounts processed on the payment card acceptance account of the merchant, comprise at least three (3) payment card refund transaction amounts.

6. The method of claim 4, further comprising receiving the security code texted to the cell phone number of merchant on the registration web link.

7. The method of claim 6, further comprising verifying that the security code texted to the cell phone number of merchant matches with the security code in the received information.

8. The method of claim 1, further comprising notifying the merchant that registration is confirmed after verifying.

9. The method of claim 8, further comprising notifying the merchant that registration is confirmed after verifying by an e-mail to the e-mail address received from merchant, a text to the cell phone number received from merchant, a voice mail on the telephone number (land line) received from merchant, or a letter via regular mail to the address received from merchant.

10. The method of claim 1, further comprising updating a database containing authentication information associated with the merchant based on the authenticating of the merchant.

11. The method of claim 1, wherein the online transaction is a provision of services to the merchant and wherein the entity is a payment card company.

12. The method of claim 1, wherein the online transaction is a payment transaction and wherein the entity is a payment cardholder.

13. A method for an entity to authenticate a merchant in order for the entity to conduct an online transaction with the merchant, said method comprising:
receiving information concerning the merchant by the entity, said information comprising an e-mail address of the merchant, a credit number of the merchant, and one or more data selected from the group consisting of: a name of the merchant, an address of the merchant, a telephone number of the merchant (land line), a name of individual representing the merchant, a cell phone number of the individual representing the merchant, and an attestation that the information provided by merchant is accurate and true and that the individual representing the merchant is authorized to act on behalf of the merchant and to represent the merchant;
conveying at least a registration web link to the e-mail address of the merchant, and a text of a security code to the cell phone number of the merchant;
processing a transaction amount on a payment card of merchant using the payment card number of the merchant;
processing three (3) payment card refund transaction amounts on a payment card acceptance account of merchant;
receiving information on the registration web link from the merchant, said information including the amounts of the three (3) payment card refund transactions obtained by the merchant from an acquiring bank of the merchant;
receiving on the registration web link from the merchant, the security code texted to the cell phone number provided by the merchant;
verifying that the amounts of the three (3) payment card refund transactions processed on the payment card acceptance account of the merchant match with the amounts of the three (3) payment card refund transactions obtained by the merchant from the acquiring bank of the merchant; and
verifying that the security code texted by the entity to the cell phone number provided by merchant matches with the security code received by the entity on the registration web link from merchant.

14. A method of authenticating a first entity by a second entity, said method comprising the following steps by the second entity:
receiving information concerning the first entity, said information comprising at least an e-mail address of the first entity and a payment card number of the first entity;
conveying at least a registration web link to the e-mail address of the first entity;
processing a transaction amount on a payment card of the first entity using the payment card number of the first entity;
processing at least two (2) payment card refund transaction amounts on a payment card acceptance account of the first entity;
receiving information on the registration web link from the first entity, said information including the amounts of the at least two (2) payment card refund transactions obtained by the first entity from an acquiring bank of the first entity; and
verifying that the amounts of the at least two (2) payment card refund transactions processed on the payment card acceptance account of the first entity match with the amounts of the at least two (2) payment card refund transactions obtained by the first entity from the acquiring bank of the first entity.

15. A system for authenticating an entity, comprising:
a database configured to store authentication information associated with the entity;
a receiving device configured to receive information concerning the entity, said information comprising (i) at least an e-mail address and a payment card number of the entity and (ii) the amounts of the at least two (2) payment card refund transactions obtained by the entity from an acquiring bank of the entity;
at least one supplying device configured to supply at least a registration web link to the e-mail address of the entity; and
a processor configured to:
process a transaction amount on a payment card of the entity using the payment card number of the entity;
process at least two (2) payment card refund transaction amounts on a payment card acceptance account of the entity;
authenticate the entity by verifying that the amounts of the at least two (2) payment card refund transactions processed on the payment card acceptance account of the entity match with amounts of at least two (2) payment card refund transactions obtained by the entity from the acquiring bank of the entity; and
update, in the database, the authentication information associated with the entity based on the authenticating of the entity.

16. The system of claim 15, wherein the information received by the receiving device further comprises one or more data selected from the group consisting of: a name of the merchant, an address of the merchant, a telephone number of the merchant (land line), a name of individual representing the merchant, and a cell phone number of the merchant and an individual representing the merchant.

17. The system of claim 16, wherein the information received by the receiving device further comprises an attestation that the information provided by merchant is accurate and true and that the individual representing the merchant is authorized to act on behalf of the merchant and to represent the merchant.

18. The system of claim 16, further comprising a second supplying device configured to supply a text of a security code to the cell phone number of the entity.

19. The system of claim 18, wherein the receiving device is configured to receive from the entity the security code texted to the cell phone number of the entity.

20. The system of claim 19, wherein the processor is configured to authenticate the entity by verifying that a security code texted to the cell phone number of entity matches with a security code received from entity.

21. The system of claim 15, wherein the at least two (2) payment card refund transaction amounts processed on the payment card acceptance account of the entity, comprise at least three (3) payment card refund transaction amounts.

22. The system of claim 15, wherein the entity is a merchant, the system conducts an online transaction with the merchant, and the online transaction is a provision of services by a payment card company.

23. The system of claim 15, wherein the entity is a merchant, the system conducts an online transaction with the merchant, and the online transaction is a payment transaction by a payment cardholder.

24. A system for authenticating a merchant, comprising:
a database configured to store authentication information associated with the merchant;
a receiving device configured to receive information concerning the merchant, said information comprising (i) at least an e-mail address and a payment card number of the merchant and (ii) the amounts of the at least two (2) payment card refund transactions obtained by the merchant from an acquiring bank of the merchant;
at least one supplying device configured to supply at least a registration web link to the e-mail address of the merchant; and
a processor configured to:
process a transaction amount on a payment card of the merchant using the payment card number of the merchant;
process at least two (2) payment card refund transaction amounts on a payment card acceptance account of the merchant;
authenticate the merchant by verifying that the amounts of the at least two (2) payment card refund transactions processed on the payment card acceptance account of the merchant match with amounts of at least two (2) payment card refund transactions obtained by the merchant from the acquiring bank of the merchant; and
update, in the database, the authentication information associated with the merchant based on the authenticating of the merchant.
